(19) United States
(12) Patent Application Publication
(10) Pub. No.: US 2001/0032433 A1
(43) Pub. Date: Oct. 25, 2001

(54) Joining extruded sections

(76) Inventor: Len Harris, Buckinghamshire (GB)

Correspondence Address: Finnegan, Henderson, Farabow,, Garrett & Dunner, L.L.P., 1300 I Street, N.W., Washington, DC, 20005-3315, US

(21) Appl. No.: 09/817,185

(22) Filed: Mar. 27, 2001

(30) Foreign Application Priority Data
Mar. 27, 2000 (GB) 0007396.5

(51) Int. Cl. E04B 2/00; E04B 5/00; E04B 9/00; A47K 1/00; E04G 3/00; E04G 5/06; F21V 21/00

(52) U.S. Cl. 52/506.06; 52/506.01; 248/220.21; 248/220.22

(57) ABSTRACT

There is described a bracket for joining together extruded sections, particularly for the construction of suspended ceiling frameworks, The bracket comprises a pair of spaced and parallel engagement edges which can be rotated into engagement with a pair or opposed recesses in the extruded section. A resilient finger engages with the extruded section to prevent reverse rotation of the bracket relative to the section.

The present invention relates to brackets for joining extruded sections, and is particularly concerned with the construction of frameworks for supporting suspended ceilings. In a suspended ceiling structure, a number of “I” or inverted “T” sections are supported on hangers so as to extend in parallel across the room, at the height of the desired suspended ceiling. These sections generally extend across the shorter dimension of the room, and are referred to as “main runners”. Arranged at right angles to the main runners, “noggins” extend between adjacent main runners, with the longitudinal axes of the noggins lined up so that the noggins and main runners produce a grid. The squares or rectangles of the grid are arranged to coincide with the dimensions of ceiling panels, which are laid on to the flanges of the main runners and noggins to complete the ceiling structure.

GB Patent No. 1,520,384 describes a blank for the construction of a bracket for joining extruded aluminium sections, the finished bracket having a first, rectangular portion and a second, truncated lozenge-shaped portion set at right angles to the first portion. The bracket is intended for use with extruded “I” or “T” sections which have a pair of opposing longitudinally-extending recesses extending along the edges of the web of the section. The dimensions of the brackets and the extruded section are such that parallel edges of the first, rectangular, portion of the bracket are receivable in respective ones of the recesses of a first extruded section. The lozenge-shaped portion of the bracket can then be offered between the recesses of a second extruded section, and rotated to bring extremities of the lozenge into engagement with respective ones of the recesses of the second extruded section. The rotation of the bracket relative to the second extruded section is stopped when an edge of the first portion of the bracket contacts a flange of the extruded section. In this position,

The two extruded sections are thus joined together at right angles, but by reversing the rotational motion the parts may be separated.

A disadvantage of this bracket is that only identical extruded sections can be joined together. Furthermore, inadvertent impacts on the joined sections during construction of a suspended ceiling framework may cause rotations of the brackets, leading to the joints of the framework being released.

An objective of the present invention is to provide a bracket for joining first and second extruded sections together, the bracket being easily engageable with a first extruded section and including detent means to prevent its disengagement therefrom.

A further objective of the present invention is to provide a bracket for joining together two extruded sections of different cross-sectional shape, or for joining a member of dissimilar section or material to an extruded section.

According to an aspect of the invention, there is provided a bracket for mounting to an elongate section having first and second opposed parallel recesses, the bracket comprising:

a fixing plate having:

a first engagement edge receivable in said first recess at a first longitudinal position of the section;

a second engagement edge coplanar with, C extending parallel to, and facing away from said first engagement edge, the second engagement edge being receivable in the second said recess at a second longitudinal position offset in a first sense from the first longitudinal position; and

resilient detent means facing away from said first engagement edge and engageable with said elongate section adjacent said second recess at a position spaced longitudinally relative to the section in a second sense from the first longitudinal position.

An embodiment of the present invention will now be described in detail with reference to the accompanying drawings, in which:

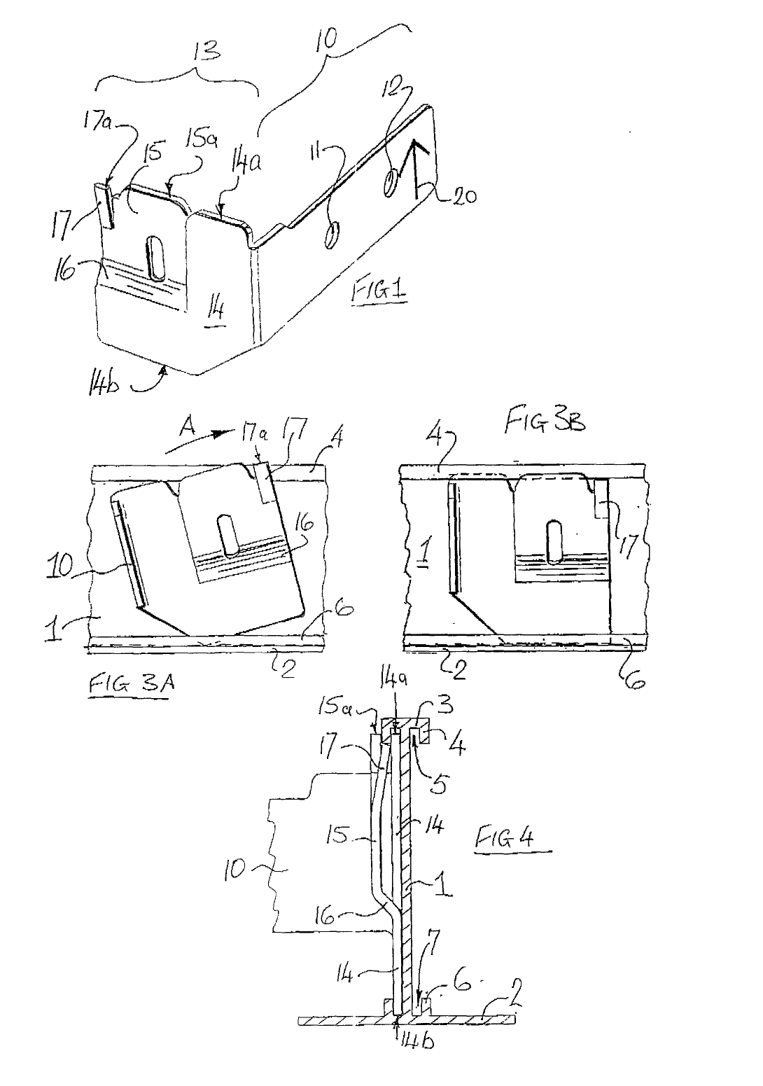

FIG. 1 is a perspective view of the bracket;

FIG. 2A is a perspective view of the bracket offered up to an extruded section for fixing thereto;

FIG. 2B is a perspective view from below, showing the bracket in its mounted position relative to and extruded section;

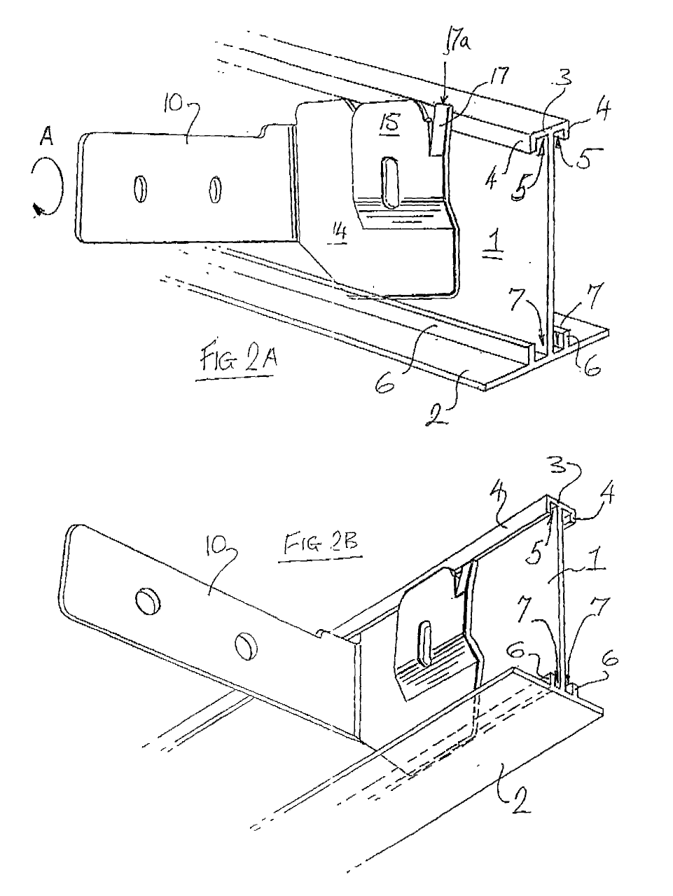

FIGS. 3A and 3B are side views showing the bracket and the extruded section in the positions shown in FIGS. 2A and 2B; and

FIG. 4 is an end view showing the bracket mounted to an extruded section.

Referring now to the drawings, the joining bracket is seen in FIG. 1, and the mounting of the joining bracket to an extruded section is illustrated in FIGS. 2 to 4. The extruded section of FIGS. 2 to 4 is of an asymmetric “I” section, having a generally vertical web 1, a wide horizontal flange 2 at the lower end of the web 1, and a narrow horizontal flange 3 at the upper end of the web 1. Depending from the edges of the upper flange 3 are a pair of ribs 4, to define downwardly-open upper recesses 5 between the web 1 and the respective rib 4 on each side of the web 1 of the section. Upwardly extending ribs 6 are formed on the upper surface of the lower flange 2, on either side of the web 1. The ribs 6 are aligned with the ribs 4 and define upwardly-open recesses 7 aligned with the downwardly-open recesses 5.

The joining bracket comprises a mounting plate 10, provided with fastener-receiving openings 11 and 12 for fixing the plate 10 to the web 1 of an extruded section (not shown) by means of threaded fasteners such as screws or bolts, or expanding fasteners such as “pop” rivets.

The mounting plate 10 is shown in the figure as an elongated rectangular plate. To one end of the mounting plate 10 is attached a fixing plate 13, for engagement with a pair of spaced recesses 5 and 7 of the extruded section shown in FIGS. 2 to 4. Due to the symmetry of the extruded section, the fixing plate 13 may be mounted to the section on either side of the web 1.

The fixing plate 13 comprises a generally “L”-shaped region 14, having oppositely--facing parallel engagement surfaces 14a and 14b. Within the “L”-shaped region 14, a generally rectangular raised region 15 lies in a plane parallel to the region 14 but spaced therefrom in the direction of the mounting plate 1. The spacing between the planes of the regions 14 and 15 is arranged to be substantially equal to the thickness of the ribs 4 of the extruded section. The region 15 is joined to the region 14 by an inclined ramp section 16. As can be seen from the figures, the raised region 15 has an upper edge (as seen in the figures) 15a extending substantially parallel to and slightly below the engagement surface 14a of the region 14.

At the corner of the raised region 15 remote from the region 14, an inclined finger 17 extends from the region 15 towards the plane of the region 14. The finger 17 terminates in an end surface 17a positioned between the planes of the regions 15 and 14, and positioned below the respective edges 15a and 14a of those regions.

In order to attach the bracket to the extruded section, the bracket is positioned with the plane of the fixing plate 13 generally vertical, and the plane of the mounting plate 10 inclined to the vertical. The bracket is then offered up to the extruded section so that the region 14 of the fixing plate 13 contacts one side of the web 1 of the section In this position, shown in FIGS. 2A and 3A, engagement surface 14a of region 14 is positioned slightly below recess 5, and engagement edge 14b is positioned slightly above recess 7. Raised region 15 and finger 17 abut the outer face of the rib 4.

The bracket is then rotated in the direction shown by arrow A of FIG. 2A, so that the engagement edges 14a and 14b enter the respective recesses 5 and 7, the final position being shown in FIGS. 2B and 3B, during this rotation, the resilient finger 17 is a deflected towards the region 15 until the end surface 17a of the finger clears the lower edge of the rib 4. The resilient finger 17 then moves away from the region 15 so that the end surface 17a of the finger engages the edge of the rib 4, as shown in FIG. 2B.

In this position, the edge 14a of the region 14 engages the under surface of the flange 3 within the recess 5, while the edge 14b engages the upper surface of the flange 2 within the recess 7. The two edges 14a and 14b are offset in the longitudinal direction of the section, so that when the position shown in FIGS. 2B and 3B is reached, further rotation in the direction of arrow A is prevented. The engagement of the end surface 17a of the finger 17 with the rib 4 prevents rotation of the bracket relative to the section in a direction opposite to that of arrow A. In the position shown in FIGS. 2B and 3B, the bracket may be moved along the section, but may not be detached therefrom.

If the bracket is to be detached from the section, then a tool is inserted between the finger 17 and the web 1 of the section to urge the resilient finger 17 away from the web and out of engagement with the edge of rib 4. While the finger 17 is disengaged from the rib 4, the bracket may be rotated in the direction opposite to arrow A, to move the bracket from the position of FIG. 2B to the position of FIG. 2A. The bracket can then be removed from the section.

It is important to note that the edges 14a and 14b of the region 14 are positioned so as to engage the flanges of the section at longitudinally offset positions along the length of the section. This offset engagement provides a limit to the rotation at the bracket during mounting to the section. It is likewise important to note that the resilient finger 17 is offset from at least a portion of the engagement edge 14b, so that in the longitudinal direction of the section, the edge 14b lies between the edge 14a and the finger 17. En this way, the engagement between the finger 17 and the rib 4 cooperates with the engagement between the edge 14b and the flange 2 to prevent reverse rotation of the bracket.

In order to assist and operative to orient the bracket correctly for initial mounting, a direction indicator 20 may be provided on the bracket, optionally in association with a written instruction. In the embodiment shown, and arrow 20 is provided on the mounting plate 10, and may be accompanied by exposure he wording such as “up”. The indicator 20 may be provided on any part of the bracket, but is preferably placed so as to remain visible when the region 14 is offered up to the web 1 of the section.

In an alternative embodiment, not shown, the region 15 may be omitted, and the resilient finger 17 may extend directly from a part of the region 14. The positioning of the resilient finger 17 a relation to the parallel engagement edges 14a and 14b is such that the engagement edge 14b extends, when considered in the direction of edges 14a and 14b, between the engagement edge 14a and the finger 17.

In order to assemble a suspended ceiling framework, a plurality of main runners are fixed so as to extend across the room. Brackets are offered up to the main runners at appropriate positions, and a rotated surface to bring the brackets into the engaged position shown in FIGS. 2B and 35. Brackets are positioned on the adjacent main runners with their mounting plates 10 in alignment, and noggins can then be attached to the mounting plates 10 so as to extend between the main runners. The noggins may be of the same extruded section as the main runners, and the mounting plates 10 may be dimensioned so as to be engageable with the recesses 5 and 7 of the noggins. A resilient tine may be formed in the mounting plate 10 by providing a “C” shaped slit or slot in the mounting plate 10 and deflecting the material bounded by the slit or slot slightly out of the plane of the mounting plate 10. The tine will then engage the web of the noggin when the upper and lower edges of the mounting plate 10 are slid into the recesses 5 and 7 from the end of the noggin, and will provide fictional engagement to retain the bracket in engagement with the noggin. The mounting plate 10 may be formed with two such times, one extending on each side of the plane of the mounting plate 10.

A perimeter batten may extend round the walls of the room at ceiling height, and edge noggins may extend from the batten to the main runners. Such edge noggins may be of different material or shape from the main runners and noggins, but may still be attached to the main runners by means of the brackets of the invention.

While the bracket has been described in relation to forming a framework for supporting a suspended ceiling, it is to be understood that the bracket may be engageable with a pair of opposed recesses in an elongate section used in other structural applications. For example, the fixing plate may be used to attach garment hanging rails to an elongate section fixed to a wall or other structure. In such an application, the mounting plate 10 may be modified so as to the attachable to, or so as to function as, a garment hanging rail.

1. A bracket for mounting to an elongate section having first and second opposed parallel recesses, the bracket comprising;
a fixing plate having:
a first engagement edge receivable in said first recess at a first longitudinal position of the section;
a second engagement edge coplanar with, extending parallel to, and facing away from said first engagement edge, the second engagement edge being receivable in the second said recess at a second longitudinal position offset in a first sense from the first longitudinal position; and
resilient detent means facing away from said first engagement edge and engageable with said elongate section adjacent said second recess at a position spaced longitudinally relative to the section in a second sense from the first longitudinal position.

2. A bracket according to claim 1, further comprising a mounting plate including mounting means for attaching the mounting plate to a third component.

3. A bracket according to claim 1 or claim 2, wherein the first engagement edge and the second engagement edge are upper and lower parallel edges of an “L”-shaped region of the fixing plate.

4. A bracket according to claim 3, wherein the resilient detent means comprises a resilient finger having an end surface engageable with said elongate section.

5. A bracket according to claim 4, wherein the resilient finger extends from a substantially rectangular region of the fixing plate bounded on two sides by the “L”-shaped region.

6. A bracket according to any of claims 2 to 5, wherein the mounting plate has opposing edges for engaging opposed recesses of the third compartment.

7. A bracket substantially as herein described with reference to FIG. 1, FIG. 2, FIG. 3 or FIG. 4 of the accompanying drawings.
